(19) United States
(12) Patent Application Publication
(10) Pub. No.: US 2016/0215798 A1
(43) Pub. Date: Jul. 28, 2016

(54) HYDRAULIC PUMP

(71) Applicants: CHARLES DAVID GILLIAM, Baton Rouge, LA (US); Steven David Glilliam, Baton Rouge, LA (US)

(72) Inventors: CHARLES DAVID GILLIAM, Baton Rouge, LA (US); Steven David Glilliam, Baton Rouge, LA (US)

(73) Assignee: Gilliam Consulting, L.L.C.

(21) Appl. No.: 14/607,711

(22) Filed: Jan. 28, 2015

(51) Int. Cl. F15B 13/04; F15B 15/20

(52) U.S. Cl. CPC F15B 13/04; F15B 15/20

(57) ABSTRACT

A hydraulically-driven pump is disclosed having one or more rotating discs within a housing. The housing is sealed and hydraulic fluid under pressure supplied to the housing maintains a positive pressure within the housing. The pump is mechanically-driven by hydraulic fluid rather than by an electric motor. With no electrical power supplied directly to the pump, there is reduced risk of spark generation within the pump. The rotating discs may include small surface perturbations.

### BACKGROUND OF THE INVENTION

1. Field of the Invention

The invention relates to a pump, and more particularly to a hydraulically-driven disc pump with a pressurized and sealed motor housing. The disc or discs may have a plurality of surface perturbations covering part of the surface area of one side of the disc or discs.

2. Background

In many industrial settings, there is a need to pump potentially flammable liquids. This need can arise, for example, when a flammable liquid is spilled or when a combination of materials is found in a pit or sump. In the latter setting, it may be impossible or impractical to determine exactly what the chemical composition is of the material to be pumped. Another example is the need to empty or evacuate tanks, large cylindrical containers and the like. Again, when this need arises, the workers on site may not know what sort of chemicals are involved. Or the workers may know, or have reason to believe, that flammable or otherwise hazardous chemicals are involved.

In these settings, there is a need for a pump that can operate effectively and efficiently without causing any additional risk. When there are flammable liquids or gases in the area, a typical pump, driven by an electric motor, raises a risk of fire or explosion. Electric motors spark and a spark may be all it takes to set off a disastrous industrial accident. There are electric motors designed for use in hazardous situations, but any use of electricity in an area with flammable liquids and gases is inherently risky.

There is also a need for a pump that can handle a wide variety of materials, including mixtures of oil and gas, mixtures of liquid and solid particles, and various other types of hazardous materials. A boundary layer pump offers substantial benefits in these settings. Boundary layer or bladeless turbines, pumps, and other related turbo-machinery have been known for 100 years or more. Nikola Tesla obtain a patent (U.S. Pat. No. 1,061,142) for such a device in 1913. The Tesla patent disclosed a multiple-disc pump that utilized rotating flat discs with no blades, vanes, or propellers. Such pumps have been referred to as disc pumps, boundary layer pumps, or bladeless pumps.

In related U.S. Pat. No. 1,061,206, Tesla disclosed a fluid-driven boundary layer or bladeless turbine which may be utilized as a prime mover in various applications. The Tesla bladeless turbine, when used as the driving force for a hydro-electric generator, could transform the kinetic energy of a flowing fluid into electrical energy. In U.S. Pat. No. 1,329,559, Tesla disclosed another application of the bladeless turbine, this time in an internal combustion engine. The Tesla patents show early disclosures of rotational machines using bladeless or boundary layer discs.

Unlike more traditional centrifugal pumps which utilize vanes, blades, augurs, buckets, pistons, gears, diaphragms, and the like, boundary layer pumps, such as those described by Tesla, typically utilize multiple rotating parallel discs. Disc pumps, as these machines are sometimes called, utilize the fluid properties of adhesion and viscosity. These fluid properties combine to create an interaction between the fluid and the rotating flat discs that allows the transfer of mechanical energy from the rotating discs to the fluid.

Boundary layer or disc pumps (both name are used in the industry and both will be used interchangeably herein) have been reported to have advantages over more traditional pumps, especially when utilized for pumping fluids other than cool, clean, homogenous liquids. The vanes, buckets, or the like, of traditional pumps wear and lose effectiveness due to normal friction and/or impingement with particles such as sand or other abrasives. However, the flat surfaces of boundary layer pumps are much less susceptible to wear. It is not unusual for such a pump to show little or no wear even after extended use.

Boundary layer pumps have been found to be especially effective for pumping high viscosity fluids wherein the efficiency of such pumps may actually increase as the fluid viscosity increases. Boundary layer pumps have also been reported to be more cost effective in terms of reliability and decreased downtime for pumping problematic multiphase fluids, which may comprise gases, liquids, and/or solid materials. Boundary layer pumps have been found to greatly reduce maintenance costs and downtime when used to replace more traditional pumps in these demanding settings.

Typical vaned centrifugal pumps often require precise gaps between the impellors and the pump housing. When the impellor vanes or blades of such a pump begin to wear, the pump becomes less efficient and may either pump less fluid or produce less outlet pressure, depending upon the application. Disc pumps, on the other hand, are not as dependent upon spacing of the discs. This characteristic is yet another advantage provided by disc pumps over traditional bladed-impellor centrifugal pumps.

Due to the absence of spinning blades or impellers, boundary layer pumps are more gentle on sensitive fluids than are traditional centrifugal pumps. Shear-sensitive fluids or fluids containing fragile or delicate solids may be safely pumped with boundary layer pumps. For example, boundary layer pumps have been used to pump water containing live fish without harming the fish.

Cavitation is another problem that sometimes arises with traditional axial, bladed, centrifugal, and mixed-flow pumps. Cavitation describes a vacuum-like condition in the pump which can occur when liquid in the low-pressure area of the pump vaporizes. Vapor bubbles collapse or implode when they reach the high pressure area within the pump. This result can occur due to vapor bubbles formed within the pump, as described above, or due to a mixed-phase fluid entering the pump (i.e. a liquid with entrained gas). Cavitation can create a shock wave powerful enough to damage a pump, other equipment, or connections to the pump or other equipment.

Cavitation is less likely in a disc pump, because the fluid flow changes are more gradual. Much of the flow within a disc pump is laminar, rather than turbulent, which also tends to reduce the risk of cavitation. The pressure differences within a disc pump are typically lower than those seen in bladed-impellor centrifugal pumps, which further reduces the risk of cavitation. When the pump is used with flammable or potentially explosive liquids, the reduced risk of cavitation is a major benefit of the disc pump design.

One of the most important advantages of the disc pump is the greatly reduced wear. This advantage is of particular importance when the fluids being pumped contain sand, grit, or other small, abrasive particles. Such a fluid can quickly wear down the impellor blades in a typical centrifugal pump, while the same fluid may cause little or no damage to a disc pump. Another way to explain this distinction is to consider the angle of impingement between the solid particles and the rotating impellor. The higher the angle of impingement (i.e., the closer to 90°) between the particle and the impellor, the greater the damage. In a traditional bladed impellor centrifugal pump, the solid particles impinge the vanes or blades of the impellor at large angles, often close to 90°. In a disc pump, if the solids reach the disc at all, the angle of impingement will be quite low. Because a rotating disc within a disc pump creates a boundary layer, and because the flow in the inner sections of the pump housing is primarily laminar, entrained solids rarely reach the discs, but will instead be gently moved from the inlet to outlet of the pump.

This benefit is also important for a pump used with a variety of materials. For example, if a pump is used to remove the liquid remaining in a pit or sump, it is likely that sediment and other particulate material is mixed with the liquid. These solid materials could be quite abrasive and cause damage to a traditional centrifugal pump. A disc pump can greatly reduce this problem.

Traditional centrifugal pumps are highly subject to vibrations as a natural result of impact of the vanes and blades with the fluids pumped. This vibration problem is highly exacerbated when multiphase fluids are pumped that may include solids, liquids, and gases. Accordingly, the shaft rotation speed of traditional pumps, especially those used for pumping multiphase fluids, is limited to avoid destroying the pump due to vibration damage. The limited shaft rotational speeds result in lower pump output, limited horsepower, and generally less pumping capability.

On the other hand, boundary layer pumps with flat, smooth discs which may be easily balanced and produce little or no vibration when spinning within a fluid even at relatively higher rotational speeds. Typical boundary layer pumps do not utilize lifting surfaces on the rotating elements. Higher rotational speed is directly related to pump flow rates in boundary layer pumps, thus permitting significantly increased pump rotation speeds when pumping multiphase fluids which may contain solids, liquids, and gases. Moreover, boundary layer pumps have been found to not only increase the output under these difficult pumping conditions as compared to traditional pumps, but also have been found to be much more reliable.

When a pump is used to remove waste material in an industrial setting, it is quite possible the material to be pumped will include liquid, gas, and solid materials. A traditional centrifugal pump might emulsify the liquid and gas, and be eroded by the solids. A disc pump can move such materials more gently, eliminating or greatly reducing the emulsification and largely avoided the abrasion of the pump surfaces. For all these reasons, a disc pump is an ideal pump design for use with dangerous materials, especially with flammable or explosive materials.

But some rotational force is needed to drive the disc pump. In most applications, disc pumps are powered by electrical motors. This works well in most situations, but in a flammable or explosive environment, an electrical motor will create a spark risk. Even electrical motors designed for industrial settings cannot completely eliminate this risk. Electricity is inherently dangerous around highly flammable or explosive materials.

In addition, a typical electric motor may not be able to withstand the environment faced by an industrial waste pump. For example, if a large pit contains a mixture of potentially flammable liquids, it may not be practical to lower a hose to the bottom of the pit to remove the liquid. Instead, in order to ensure there is sufficient pump head, it may be necessary to lower the pump into the pit. Lowering an electric motor into a pit full of flammable liquid could be extremely dangerous. Some of the liquid, or at least some vapors of the liquid, could enter the electric motor housing. If that happens, there is a high risk of fire or explosion due to the sparking inside the electric motor housing.

Hydraulic motors are mechanical devices that operate somewhat like a pump in reverse. A viscous fluid (i.e., hydraulic fluid) is supplied to the motor under pressure. The fluid is used to force a rotor to rotate. The rotor may resemble the impellor of a typical centrifugal pump. The hydraulic fluid then exits the motor housing and is returned to the fluid source. This process is repeated as long as the hydraulic motor is needed. Some type of hydraulic pump—typically an electric motor driven pump—is used to supply the hydraulic fluid to the hydraulic motor.

Hydraulic motors offer a substantial benefit when used in an area with flammable or explosive materials. Unlike an electric motor, there is no electricity supplied to or used by a hydraulic motor. For that reason, a hydraulic motor is an excellent choice for supplying power to a disc pump to be used as an industrial waste pump. That is the arrangement of the present invention.

There are, however, two additional advantages of the present invention. The hydraulic motor is contained within a sealed housing. The motor's fluid outlet is open to the interior of the sealed housing. There is a fluid return line connected to the outer wall of the housing. This configuration allows the hydraulic fluid to pressurize the housing, and that pressure ensures no foreign matter enters the motor housing. This benefit is important when the apparatus is being used in a dirty industrial setting.

The bearings used with the hydraulic motor of the present invention are positioned inside the sealed, pressurized housing. That allows the hydraulic fluid to lubricate and cool the bearings. It also ensures the bearings remain clean. A shaft seal is used, where the hydraulic motor shaft exits the housing, and a small amount of hydraulic fluid is allowed to escape through the seal in order to lubricate and cool the seal. The hydraulic fluid lost in this way is not typically a problem for this type of pump, because the pumps are used primarily to pump waste material. A small amount of hydraulic fluid added to the mixture being pumped is unlikely to be a problem in this situation.

It is further desirable for a pump to be operable from a safe distance, in case the risk of fire, explosion, exposure, or contamination is high. A hydraulically-drive disc pump according to the present invention offers that capability, because the pump may be moved into position from a remote location. Longer hydraulic supply and return lines may be needed for this type of operation, but it is feasible.

The pump of the present invention may also be useful for pumping out tanks or other containers that may contain hazardous materials. The pump may be configured with a flange on the inlet line so that a hose can be attached or to allow the pump to be connected directly to a tank or other container. The pump could be used with little or no risk of fire or explosion, and with minimal damage or emulsification of the material being pumped.

Another potentially useful application of the pump of the present invention would be in mines or other environments that might have dangerous levels of explosive gases in the air. Longer hydraulic supply and return lines might be needed in this setting, but using the present invention in such a space would eliminate, or at least greatly reduce, the risk of explosion due to a spark. Moreover, if the material to be pumped is potentially fragile, the combination of the hydraulic motor drive and the disc pump offer benefits not possible with prior art designs.

### BRIEF SUMMARY OF THE INVENTION

The present invention utilizes a unique design that combines a hydraulic drive motor in a sealed, pressurized housing with a disc pump. The invention is expected to have many useful applications, but may be of particular utility in situations involving flammable liquids and multiphase fluids with solids, liquids, and gases. Such fluids are typical of oil and gas wells, geothermal energy production and tar sands oil extraction applications. The invention provides improved pump performance without reducing the long-wear and high-reliability attributes described above. These benefits may be of value in many industrial settings.

The present invention is also particularly suitable to pumping out industrial waste from pits, tanks, other containers, or from spills. The present invention can be used where the waste material poses a fire or explosion risk, or when it is not practical to determine whether such a risk exists.

In a preferred embodiment, the invention has [insert from claims]

### BRIEF DESCRIPTION OF THE SEVERAL VIEWS OF THE DRAWING(S)

FIG. 1 is a cross-sectional view of a preferred embodiment of the present invention.

FIG. 2 is a perspective, cut-away view of an alternative embodiment of the present invention.

FIG. 3 is a perspective view of a disc having recessed surface perturbations.

FIG. 4 is a cross-sectional view of the disc shown in FIG. 3.

FIG. 5 is a perspective view of a disc having raised surface perturbations.

FIG. 6 is a cross-sectional view of the disc shown in FIG. 5.

### DETAILED DESCRIPTION OF THE INVENTION

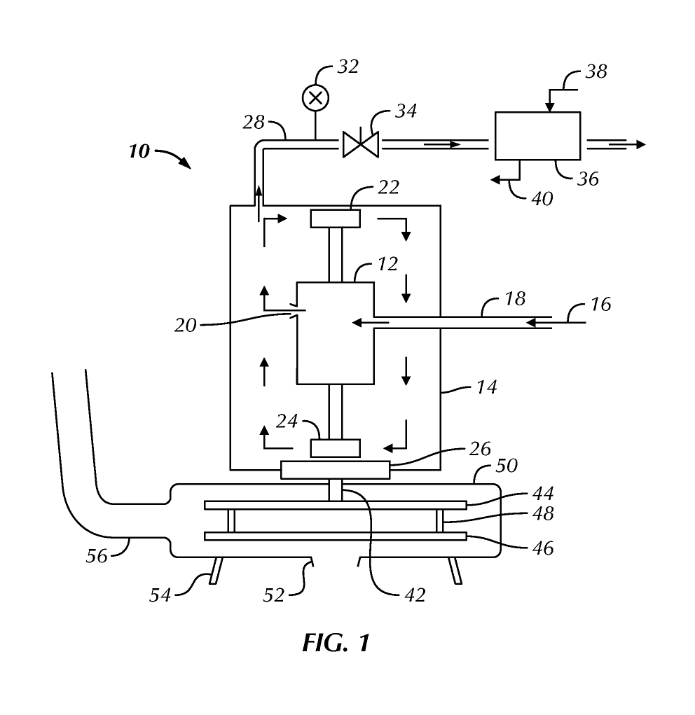

FIG. 1 shows a cross-section of the key components of a preferred embodiment of the present invention. A hydraulic pump 10 is powered by a hydraulic motor 12, which is positioned within a sealed housing 14. Pressurized hydraulic fluid (designated by arrow 16) is supplied to the hydraulic motor 12 via a pressurized hydraulic fluid supply line 18. This fluid powers the hydraulic motor 12 in a conventional manner. Hydraulic motors are well-known in the art, and for that reason, the hydraulic motor 12 of the present invention is shown merely in block form. Any conventional hydraulic motor design may be used with the present invention as long as the motor has sufficient power to operate the pump.

The pressurized hydraulic fluid 16 exits the hydraulic motor 12 via a port 20 and thus enters the otherwise vacant interior of the sealed housing 14. The hydraulic fluid 16 leaves the sealed housing 14 via a pressurized hydraulic fluid return line 28. By allowing the hydraulic fluid 16 to fill and pressurize the interior of the sealed housing 14, two important functions are performed. First, the hydraulic fluid 16 serves as a lubricant for bearings, such as the upper drive shaft bearing 22 and the lower drive shaft bearing 24, shown in FIG. 1. Other rotating and wear components are also lubricated and cooled by the hydraulic fluid 16 as it moves around the interior of the sealed housing 14. For example, the draft shaft seal 26 is lubricated by hydraulic fluid 16 by allowing a very small amount of the fluid 16 to pass through the seal 26.

Second, by pressurizing the interior of the sealed housing 14, that space is maintained at a higher pressure than the surrounding environment. This second function is important, because the pump of the present invention is intended for use with potentially hazardous materials. For example, the pump of the present invention might be used to pump out an old tank or reservoir that has not been unused for a prolonged period. In such a situation, the tank or reservoir may contain dirt, sand, and various other materials that could damage the hydraulic pump 10. By maintaining a positive pressure differential—that is, by ensuring the interior of the sealed housing 14 is at a higher pressure than the surrounding environment—no foreign material can possibly enter the sealed housing 14. The pressure differential ensures the hydraulic motor 12, bearings 22, 24, and any other components located in the sealed housing operate in a clean environment, even when the pump is used in very dirty conditions.

The hydraulic motor 12 powers a drive shaft 42, which is operatively connected to a pump 43. In a preferred embodiment, the pump 43 is a disc pump of a type described in more detail below. But other types of pumps could be used with the present invention, including a conventional centrifugal pump with one or more vaned impellors. A positive displacement pump (e.g., of a screw or piston design) could also be used. The reason the disc pump is preferred is its ability to handle all types of fluids in a gentle manner. Some benefits and advantages of the disc pump design are set forth above, and others are described more below.

In the embodiment shown in FIG. 1, a disc pump 43 is connected to the sealed housing 14 and is operatively connected to the drive shaft 42. The pump 43 in FIG. 1 has an upper disc 44, which is operatively connected to the drive shaft 42, and a lower disc 46, which is connected to the upper disc 44 via a plurality of disc pins 48. The pump housing 50 surrounds the discs 44, 46 and provides structural support for the pump 43. The inlet 52 is shown at the center of the pump 43, and uses a standoff 54 to maintain some separation between the inlet 52 and the surface of the tank, reservoir or other item being pumped. The standoff 54 is relatively small in a preferred embodiment so that the pump 43 can remove as much of the fluid as possible. A standoff 54 of as little as ½ inch may be feasible in some situations. The height of the standoff 54 will depend on the size of the pump 43 and may vary with the material being pumped.

The pump 43 has a discharge 56 located radially outward from the pair of discs. One of more hoses may be attached to the discharge to move the pumped fluid to a desired location. The discharge may have standardized hose fittings to allow for quick and easy connection and disconnection of hoses. In some situations, the material may be pumped directly into a tank on a truck or other vehicle to be removed to another site. These and other configurations of the pump discharge 56 are within the scope of the invention.

Returning to the sealed housing 14 and the hydraulic motor 12, FIG. 1 also shows optional elements in the return flow path of the pressurized hydraulic fluid 16. The pressurized hydraulic fluid return line 28 may include a pressure gage 32 and a pressure control valve 34. These components may be used to ensure that the pressure inside the sealed housing 14 is higher than that of the surrounding environment. In most situations, the sealed housing 14 will be at a much higher pressure than the surrounding environment. But if the pump of the present invention is used in deep water conditions or other environments where the material being pumped is at a high pressure, there may be a need to control the pressure in the sealed housing to ensure the positive pressure differential described above is maintained.

The pressure control valve 34 may be manually operated or may be controlled via a microprocessor system. The use of microprocessor-controlled valves is well-known in the art, and any automatically controlled valve is within the scope of the invention. A mechanical pressure regulator valve may also be used for this purpose, but such a valve might require that an additional fluid discharge line be provided for any fluid ported from the regulator.

The returning hydraulic fluid will be at a higher temperature than the fluid supplied to the hydraulic motor. If there is a need or desire to cool the returning fluid, a radiator/cooler 36 may be used. A coolant supply line 38 and a coolant return line 40 are shown in FIG. 1. Any type of cooler that is rated to handle high pressure fluids may be used for this purpose. The coolant flow rate may be controlled to achieve a desired temperature for the returning hydraulic fluid.

A cross section of a typical boundary layer or disc pump 43 is shown in FIG. 2. The portion of interest for this description is seen on the right end of the drawing. A pump housing 50 surrounds an upper disc 44 and lower disc 46. Pins 48 connect the discs together. The pump inlet 52 is shown with a standard type of flange fitting 68. This design may be used when additional hoses are attached to the pump inlet 52. In the preferred embodiment of the invention, it is expected that the entire hydraulic pump 10 would be lowered into the fluid to be pumped. In that type of use, the flange fitting 68 would not be used, and instead a standoff 54 (i.e., like that shown in FIG. 1) would be preferred. The flange fitting 68 has a series of holes 70 to be used to secure the inlet 52 to a hose or some other suitable fitting. The pump 43 is also shown with a base 72, which is indicative of an application where the pump 43 is relatively large and is not typically lowered into a fluid. The configuration shown in FIG. 2 would be more likely used in a permanent or less portable arrangement.

A thrust bearing 64 is shown in FIG. 2, as is a shaft seal 66. Note again the difference between FIG. 1 and FIG. 2. In FIG. 1, the drive shaft seal 26 was located in an opening in the sealed housing 14. There was no separate shaft seal in the pump 43 shown in FIG. 1. That is because the housing 50 of the pump 43 of FIG. 1 was connected directly to the sealed housing 14. Thus, the single drive shaft seal 26 was sufficient. In the design shown in FIG. 2, the sealed housing 14 may be physically separate from the pump 43. In that configuration, a shaft seal will be needed where the drive shaft 42 leaves the sealed housing 14 and another seal will be needed where the shaft 42 enters the pump housing 50.

The disc pump 43 is powered by a drive shaft 42, which is operatively connected to a hydraulic motor 12 positioned within a sealed housing 14, as described in connection with FIG. 1 above. The sealed housing 14 and hydraulic motor 12 are shown as a single block 60 in FIG. 2. The block diagram approach for the motor and housing are used in FIG. 2 because those items were already shown and described in connection with FIG. 1, above, and because the focus of FIG. 2 is on the design of the disc pump 43, which is the preferred pump type for use with the present invention.

The pump inlet 52 is aligned with the longitudinal axis of the drive shaft 42. The inlet 52, therefore, can be described as a central, coaxial inlet. The inlet 52 can take various forms. It can supply feed flow from one side of the housing 50 or from both sides of the housing. A design showing dual inlet flow from both sides of the housing is disclosed in U.S. Pat. No. 4,403,911, which is hereby incorporated by reference. FIGS. 16 and 17 of the '911 patent, and the accompanying description, show a central, coaxial inlet attached to both sides of a pump housing. The only limitation on the inlet is that it be a central, coaxial inlet. One means of providing such an inlet is shown in FIG. 2. Another is shown in the '911 patent.

A first disc 44 and a second disc 46 are also shown in FIG. 2. The upper disc 44 is operatively connected to the drive shaft 42. Any type of rotational drive member may be used to rotate the discs. A drive shaft 42 is perhaps the most common type of rotational drive member and is, therefore, shown in FIG. 2. A cylindrical drive member or any other type of rotational driving structure may be used. The drive shaft 42 in FIG. 2 is shown threaded into the upper disc 44. No particular connection means is required. All that is required is that the rotational driving member be operatively connected to the upper disc 44 such that the disc may rotate within the housing 50.

The lower disc 46 is connected to the upper disc 44 by pins 28, though other connections are also contemplated. The connecting members between the discs must be of sufficient strength to allow the upper disc 44 to cause the lower disc 46 to rotate. If additional discs, or additional pairs of discs, are used, similar connections would be required between those discs. Only the upper disc 44 is directly connected to the rotational drive member in FIG. 2, though it is contemplated that in some embodiments the rotational drive member may extend into the housing and be directly connected to other discs, as well.

The pins 28 or other members used to connect the discs to each other should be of relatively small cross section in order to reduce the turbulence caused by the rotation of such members through the housing 50 during operation of the pump. To reduce the turbulence induced by such rotation of the connecting pins 28, the pins could be formed in a tear drop or other more aerodynamic form that would reduce the fluid turbulence caused when the pins 28 are rotated through the fluid to be pumped.

The pump 43 shown in FIG. 2 is of a type known in the art. The upper disc 44 and lower disc 46 are flat and smooth. In operation, the drive shaft 42 is rotated by some driving force, and thereby rotates the discs 44, 46 within the housing 50. For purposes of explaining the operation of the pump, assume the housing 50 is filled with water. When the discs 44, 46 begin to rotate, a thin boundary layer of water near the outer surface of the discs 44, 46 will also begin to rotate. The adhesion of the water (or other liquid) to the solid surface of each disc creates drag, and that tends to pull a thin boundary layer of water along with the disc as it rotates. The two discs 44, 46 shown in FIG. 2, therefore, each cause a thin boundary layer of water to begin rotating in the same direction as the discs.

In the region between the discs, it is the viscosity of the fluid that accounts for the generation of flow. The liquid between discs 44, 46 of FIG. 2 may be understood as many thin sheets of liquid, where each thin sheet is parallel to the two rotating discs. Moving away from the discs 44, 46 and toward the center of the housing 50, we first encounter the thin boundary layers that are rotating in the same direction as the discs 44, 46 due to the adhesion forces between the discs 44, 46 and the boundary layers. The next thin layers of water are in contact with the boundary layers, and due to the viscosity of the water, these next layers of water will begin to rotate with the boundary layers. Each thin layer of water begins to rotate because the water immediately around it is rotating. This process continues until all the water in the housing 50 is rotating in the same direction as the discs 44, 46.

The pump 43, thus produces primarily laminar liquid flow. The boundary layer will experience some turbulent flow due to minor irregularities upon the surfaces of the discs 44 and 46, but the many thin layers of water (as described above) will each rotate primarily in a laminar matter. This is important, because it results in minimal mixing of the liquid within the housing. If there were perfectly laminar flow within the housing, there would be no impingement of solid particles with the discs, because such particles would remain fixed within their respective layer of laminar flow. Though this ideal scenario does not occur in practice, the prevalence of laminar flow does greatly reduce the impingement of particulates with the discs.

As the water in this example rotates with the discs, the water experiences centrifugal forces which tend to force the water radially outward from the axial center of the housing 50. The water, therefore, moves in a generally outward spiral from the axial center to the outer peripheral region of the housing 50, where the outlet 56 is positioned. Because of the process described above, the water (or other liquid) is pumped from the central, coaxial inlet 52 to the outlet 56. In FIG. 2, if the liquid entering the pump 43 has entrained gas or solid particles, these materials will be moved in the same outward spiral pattern as the liquid. The entrained material moves through the pump housing 50 with little, if any, contact with the rotating discs 44, 46.

The disc pump 43 described above may use a single rotating disc, a pair of discs (as shown in FIG. 2), or a larger number of discs, which may be arranged in pairs or as a series of individual discs. If a single disc is used in a relatively large housing, the pump will not generate as large a pump head as it would if multiple discs are used. For example, if only the upper disc 44 of FIG. 1 were used, the pump would work, but the liquid nearest the front wall (i.e., the farthest from the upper disc 44) would receive the least rotational force. The single disc pump may produce a lower pump head, lower flow rate, or both. Use of a pair of discs, as shown in FIG. 2, or use of even more discs, is generally preferred to use of a single disc if a large flow rate or pump head are required.

On the other hand, a single disc pump is the most gentle embodiment of the disc pump. When two or more discs are used, connecting pins 28, or some other connecting members, may be used to connect the discs together. These pins 28 or other connecting members rotate with the discs, causing some turbulence within the housing 50. Moreover, the rotation of connecting pins 28 can result in damage to particles or other materials impacted by the pins 28 as the discs 26 and 28 rotate. When the most gentle pumping is required, a single disc pump may be the best option. Examples of situations where this may be appropriate might include pumping of live fish or fragile solids suspended in a liquid.

A preferred embodiment of the present invention is shown in FIG. 2, which shows a perspective view of a cut-away of a disc pump 43. The inner surface of the upper disc 44, as shown in FIG. 2, is covered with small, surface perturbations 62. These surface perturbations 62 are also present on the inner surface of the lower disc 46, but cannot be seen due to the perspective presented in FIG. 2. The surface perturbations 62 create a markedly different result when the discs rotate, as compared to the description provided above. The surface perturbations 62 shown in FIG. 2 are recessed dimples, though numerous other types of small perturbations may be used, as is explained more below.

When the dimpled discs shown in FIG. 2 rotate through the liquid, the many dimples create small surface disturbances in the liquid near the disc surfaces. Small eddy currents are formed as liquid enters and leaves the many surface perturbations 62. Each dimple is small and shallow, and thus creates only a very small disturbance to the liquid near the disc surface. The collective impact, however, of many such small disturbances is a substantially more turbulent flow within the boundary layer. This turbulence may also produce a thicker boundary layer.

The more turbulent boundary layer is more adherent to the disc surface, and this increase in the adhesion force results in more rotational movement of liquid within the boundary layer. As the boundary layer rotates faster, each thin layer of water moving toward the center of the housing 50 also rotates faster. When a thicker boundary layer is formed, more liquid is impacted by the adhesion force, and thus more liquid movement results. By creating a more turbulent boundary layer, the discs of the present invention create more flow and a larger pump head as compared to a traditional disc pump with smooth flat discs.

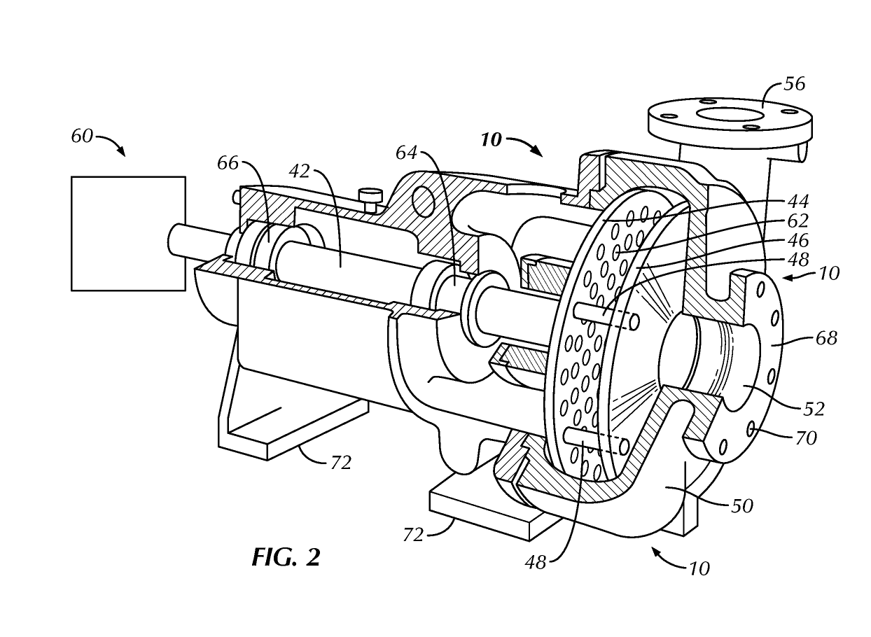

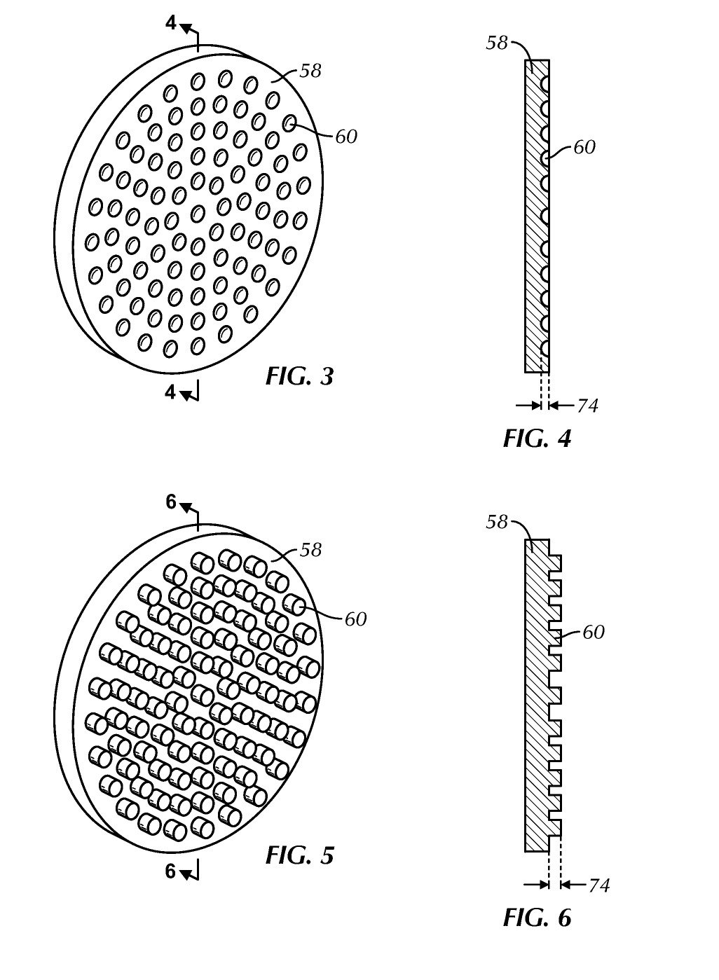

Recessed surface perturbations 62 are shown in more detail in FIGS. 3 and 4. More than half of the surface of the disc 58 is covered with recessed surface perturbations in FIG. 3. In a preferred embodiment, 70% or more of the disc surface 58 is covered. Each surface perturbation 62 is small relative to the full disc surface 58. Indeed, each surface perturbation 62 covers an area that is less than 5% of the surface of the side of the disc. Many surface perturbations 62 are needed to cover at least half (i.e. 50% or more) of the surface of one side of the disc. In a preferred embodiment, the surface perturbations 62 are only on one side of the disc, though a disc positioned at an intermediate point within the housing 50 might have dimples on both sides and thus be used to produce flow on both sides of the disc.

FIG. 4 shows a cross section of the disc. Many surface perturbations 62 are shown. In a preferred embodiment, the surface perturbations 62 have a depth 74 equal to roughly (i.e., approximately) 50% of the thickness of the disc. This depth 74 is not critical to the performance. It does provide, however, for a deep enough dimple to produce surface turbulence while also allowing the disc to retain structural strength. The benefits of the present invention, however, are not dependent upon the precise depth of the dimples. As long as there are enough dimples, and each dimple is deep enough to create a small area of turbulent flow, the benefits of the present invention will be attained. The roughly 50% preference is not a strict or precise figure, and it is not anticipated that precise depth measurements would be made of each surface perturbation 62.

The surface perturbations 62 shown in FIGS. 3 and 4 can be described as dimples. The illustrated form is recessed and semi-spherical, but these are shown merely for illustration purposes. The surface perturbations contemplated by the present invention may take many forms. The recessed perturbations 62 shown in FIGS. 3, 4 represent any type of recessed perturbation, including holes all the way through the disc.

Recessed surface perturbations 62 may be used, but raised perturbations also may be used. One example of a pattern of raised surface perturbations is shown in FIGS. 5 and 6. A disc surface 58 is shown with a plurality of raised surface perturbations 62. The raised surface perturbations 62 shown in FIGS. 5 and 6 are cylindrical. As shown in FIG. 6, the height of the raised, cylindrical surface perturbations is roughly comparable to the depth of the recessed surface perturbations 62 shown in FIG. 4. The height 50 of the cylinders 48 is about 50% of the disc thickness.

As with FIGS. 3, 4, the raised surface perturbations 62 shown in FIGS. 5, 6 are illustrative only. Indeed, the specific geometric shape of the perturbations 62 shown in FIGS. 3-6 is irrelevant. The shapes shown are effectively block diagrams meant to represent any shape of recessed (i.e., FIGS. 3-4) or raised (i.e., FIGS. 5-6) surface perturbations 62. The surface perturbations may be conical, cube-shaped, or any other shape. A mix of different shapes, together with a mix of recessed and raised surface perturbations could be used, though this is not preferred because it might unduly increase manufacturing complexity. All of these variations are represented by the general presentations of FIGS. 3-6.

The discs of the present invention have large surface areas compared to their thickness. These proportions are illustrated in FIGS. 3-6. In a preferred embodiment, the diameter of the cylindrical discs is at least five times larger than the thickness of the disc. In some configurations, this ratio may be much larger, with the disc diameter sometimes being more than ten times larger than the disc thickness. This type of construction is preferred because it is the large, circular surface area of the disc that contributes to pump performance.

The embodiments of the present invention shown in FIGS. 2-6 use many, discrete surface perturbations, rather than a few long radial ribs or waves. The surface perturbations of the present invention are not arranged in any particular pattern, and do not form radial ridges or rows. Instead, the surface perturbations are spread across the discs in a manner designed to create numerous small areas of turbulence that will collectively create a more adherent, turbulent boundary layer. This result alters the pumping performance of the disc pump.

It should be noted that the upper disc 44 differs from the lower disc 46, and any other additional discs used, in an important respect. Only the upper disc 44 is a full disc. Each additional disc (e.g., the lower disc 46 shown in FIGS. 1 and 2) must have a central, coaxial opening to allow flow within the housing 50. The need for such a central, coaxial inlet flow path is what requires the use of connecting pins 28 or other connecting means between the discs. It is possible to make the pump such that the lower disc 46 (and additional discs) is attached directly to the drive shaft, but some type of central, coaxial flow path still must be provided through the lower disc 46 (or any other additional discs). That result might be achieved by using a series of spokes between a central drive shaft an the main body of the disc, or any other physical configuration that securely connects the disc to the drive shaft while allowing flow along the central, axial direction. The means of connecting the lower disc 46 and other discs to the rotational driving force is not critical to the present invention.

Because discs beyond the upper disc 44 require some central, coaxial opening, it should be understood that the discs shown in FIGS. 3 and 5 are upper discs 44. These discs are full discs, and are, therefore, configured to be attached directly to the rotational driving member. Lower disc 46 (and any other discs that may be used) would have some type of opening, or group of openings in the center of the disc surface. In the configuration shown in FIGS. 1 and 2, the lower disc 46 has a central, coaxial opening aligned with the inlet 52. If such a disc were shown standing alone (i.e., in the manner of FIGS. 3 and 5), it would look like an annulus, and not like the solid cylinder of the actual figures. The annulus form of the lower disc 46 is not explicitly shown in FIGS. 3 and 5, but is a well understood characteristic of existing disc or boundary layer pumps.

While the preceding description is intended to provide an understanding of the present invention, it is to be understood that the present invention is not limited to the disclosed embodiments. To the contrary, the present invention is intended to cover modifications and variations on the structure and methods described above and all other equivalent arrangements that are within the scope and spirit of the following claims.

What is claimed is:

1. A hydraulic pump comprising:
a) a pressurized hydraulic fluid supply line;
b) a pressurized hydraulic fluid return line;
c) a sealed housing, the housing configured to exhaust hydraulic fluid through the pressurized hydraulic fluid return line;
d) a hydraulic motor positioned within the sealed housing, the hydraulic motor configured to receive pressurized hydraulic fluid via the pressurized hydraulic fluid supply line and to exhaust pressurized hydraulic fluid into the interior of the sealed housing;
e) a drive shaft operatively connected to the hydraulic motor;
f) a shaft seal positioned within an opening in the sealed housing, such that the drive shaft exits the sealed housing through the shaft seal;
g) at least one drive shaft bearing positioned within the sealed housing; and,
h) a disc pump positioned outside the sealed housing and operatively connected to the drive shaft.

2. The hydraulic pump of claim 1, wherein the at least one drive shaft bearing comprises an upper drive shaft bearing and a lower drive shaft bearing, both bearings positioned within the sealed housing and both lubricated by pressurized hydraulic fluid when the pump is in use, and wherein the lower drive shaft bearing is positioned near the shaft seal and on a side of the hydraulic motor nearer the disc pump, while the upper drive shaft bearing is positioned on a side of the hydraulic motor that is farther from the disc pump.

3. The hydraulic pump of claim 1, wherein the pressurized hydraulic fluid return line further comprises a pressure control valve used to maintain the pressure within the sealed housing within a desired range.

4. The hydraulic pump of claim 3, wherein the pressure control valve is positioned in accordance with the output of a microprocessor configured to monitor the pressure within the sealed housing and to adjust the position of the pressure control valve as needed to maintain the pressure within the sealed housing within a desired range.

5. The hydraulic pump of claim 1, wherein the disc pump further comprises a disc having a plurality of surface perturbations, wherein the surface perturbations cover at least 50% of the surface area of one side of the disc.

6. The hydraulic pump of claim 5, wherein the disc pump further comprises at least one pair of discs.

7. The hydraulic pump of claim 5, wherein the surface perturbations are raised.

8. The hydraulic pump of claim 5, wherein the surface perturbations are recessed.

9. The hydraulic pump of claim 5, wherein at least 25% of the surface perturbations are raised and at least 25% of the surface perturbations are recessed.

10. The hydraulic pump of claim 5, wherein the surface perturbations are holes in the surface of the disc.

11. The hydraulic pump of claim 1, wherein the disc pump further comprises
a) a pair of discs operatively connected to each other and to the drive shaft;
b) an inlet positioned near the center of the pair of discs;
c) an outlet positioned at a point radially outward from the pair of discs; and,
d) a standoff configured to position the inlet near, but not in contact with, a lower surface of a container to be pumped by the hydraulic pump.

12. The hydraulic pump of claim 1, wherein the shaft seal is lubricated by the pressurized hydraulic fluid, such that a very small amount of the pressurized hydraulic fluid may exit the sealed housing through the shaft seal.

13. The hydraulic pump of claim 1, wherein the pump is remotely operable, such that an operator may control the pump from a location a safe distance away from the potentially hazardous fluid to be pumped.

14. A hydraulic pump comprising;
a) a sealed housing;
b) a hydraulic motor positioned within the sealed housing, wherein the hydraulic motor and the sealed housing are configured to use a pressurized hydraulic fluid to power the hydraulic motor and to provide a positive pressure differential between the interior of the sealed housing and the external environment;
c) a drive shaft operatively connected to the hydraulic motor, the drive shaft extending from the inside of the sealed housing to a point outside the sealed housing;
d) a disc pump positioned outside the sealed housing and operatively connected to the drive shaft.

15. A method of pumping a potentially hazardous fluid comprising:
a) positioning a hydraulic pump in the fluid, wherein the hydraulic pump further comprises
i) a sealed housing;
ii) a hydraulic motor positioned within the sealed housing; and,
iii) a disc pump positioned outside the sealed housing and operatively connected to the hydraulic motor;
b) supplying a pressurized hydraulic fluid to the hydraulic pump, such that the pressurized hydraulic fluid powers the hydraulic motor and creates a positive pressure differential between an interior of the sealed housing and an external environment;
c) controlling the pressure within the sealed housing to ensure a positive pressure differential is maintained between the interior of the sealed housing and the external environment while also ensuring that the pressure within the sealed housing remains below a preselected pressure rating.
